(19) United States
(12) Patent Application Publication
(10) Pub. No.: US 2018/0159934 A1
(43) Pub. Date: Jun. 7, 2018

(54) Control System For Drone and Internet of Things Systems

(71) Applicant: Vaibhav Mukund Pachalla, Charlotte, NC (US)

(72) Inventor: Vaibhav Mukund Pachalla, Charlotte, NC (US)

(21) Appl. No.: 15/371,178

(22) Filed: Dec. 6, 2016

(51) Int. Cl. H04L 29/08

(52) U.S. Cl. CPC H04L 67/12

(57) ABSTRACT

My invention is an efficient, flexible, adaptable, and innovative Control System For Drone and Internet of Things Systems which will be able to control Drones, Drone Traffic, and Internet of things system systems.

### BACKGROUND

There is currently a gaping hole in the ability of the world as a whole to efficiently and effectively control the traffic of Drones. While many countries have created regulations for Drones, there has yet to be a control system implemented to deal with the impending problems of an explosion in the proliferation of Drones and no system to control these new Drones. While investigating this problem, I also have realized that this same control system could be used to support more advanced internet of Things systems applications as this system would create the infrastructure for a wide reaching system which could establish a two-way dialogue with other systems.

### SUMMARY

I have invented a Control System For Drone and Internet of Things Systems which is flexible, efficient, effective, and adaptable. This system will facilitate two-way communication between the Control System For Drone and Internet of Things Systems.

### DRAWINGS

FIG. 1 is a depiction of a possible Control System For Drone and Internet of Things Systems Network Configuration.

FIG. 2 is a depiction of a possible control hierarchy of Control System For Drone and Internet of Things Systems Control Centers.

FIG. 3 is a depiction of a flow chart of the connection procedure for when a system is trying to connect to Control system For Drone and Internet of Things Systems, what happens after it is connected, and what happens if it is connected but become disconnected.

### DETAILED DESCRIPTION

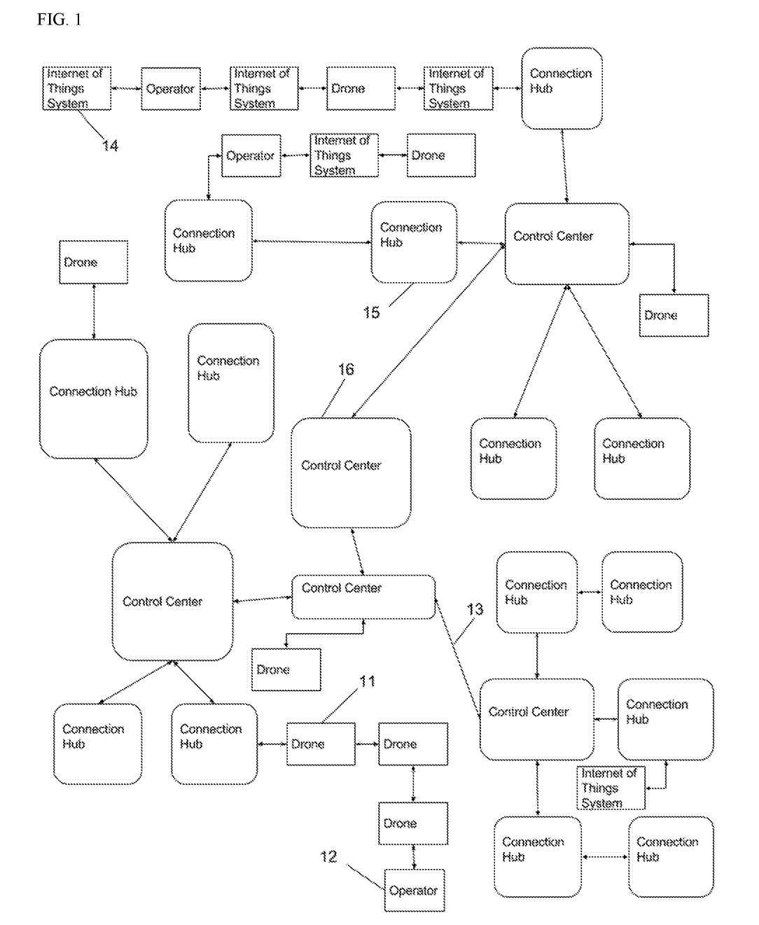

FIG. 1 is a Control System For Drone and Internet of Things Systems designed in accordance with my invention of a Control System For Drone and Internet of Things Systems. In an advantageous embodiment of my invention all control system apparatuses including but not limited to connection hubs and control centers can all share all or part of the information received by them from any Drone(s) and/or Internet of things System(s) or any other control system apparatus(es) including but not limited to connection hub(s) and control center(s) with all or some other control system apparatus(es) including but not limited to connection hub(s) and control center(s) currently connected to the Control System For Drone and Internet of Things Systems and any specified Drones and Internet of Things Systems. In an advantageous embodiment of my invention all control system apparatuses could be structured in a network configuration including but not limited to bus, ring, star, tree, or mesh configuration. In another advantageous embodiment of my invention, network structure of the control centers could be a hybrid or combination of a bus, ring, star, tree, mesh configuration. In another advantageous embodiment of my invention all communications would be sent encrypted, so only desired recipient(s) could unencrypt the message, and sent through all systems connected either directly and/or indirectly to the Control System For Drones and Internet of Things Systems including but not limited to Drones, Internet of things Systems, and control system apparatuses including but not limited to connection hubs and control centers, and the transmitting node will then listen for a response in confirmation that it's communication was received, and after a specified period of time it could resend the message and listen for a response message, and will continue to do this for a specified amount of times or until an adequate response message is received. In another advantageous embodiment of my invention a transmitting node will continue to transmit a message only until it gets an adequate response message. In another advantageous embodiment of my invention, when a system including but not limited to Drones, Internet of things Systems, and control system apparatuses including but not limited to connection hubs and control centers receives a message it will then respond by sending a confirmation packet through all of its connections system including but not limited to Drones, Internet of things Systems, and control system apparatuses including but not limited to connection hubs and control centers it is connected to. In another advantageous embodiment of my invention this cycle of receiving messages and sending a confirmation messages could be eliminated and the sender of a message would just send a desired message a desired amount of times and there would be no confirmation that the message was sent successfully. In another advantageous embodiment of my invention of my Control System For Drone and Internet of Things Systems, the cycle of sending a message and waiting for a confirmation message could continue as long as the Control System For Drone and Internet of Things Systems controllers' desire. In another advantageous embodiment of my invention, my Control System for Drone and Internet of Things Systems could use a routing protocol to propagate the message along a path by hopping from node to node until it reaches its destination, and this system could also use a self-healing algorithm to create new pathways for messages to travel if a connection breaks. At 11 there is a Drone which in an advantageous embodiment of my invention of my Control System For Drone and Internet of Things Systems a Drone could be anything that could move which could either connect indirectly to the Drone and Internet of Thing Control System through other Drone(s) and/or Internet of Thing(s) systems through either wired and/or wireless means or connect directly to a control system including but not limited to connection hubs and control centers through either wired and/or wireless means and transmit through and/or receive messages through the Control System For Drone and Internet of Things Systems control system apparatuses including but not limited to connection hubs and control centers, and anything connected to the Drone and Internet of Things Control System either directly and/or indirectly including but not limited to Drone(s), Internet of Things System(s), and control system apparatus(es) including but not limited to connection hub(s) and control center(s). At 12 there is an Operator which in an advantageous embodiment of my invention of my invention an Operator could be anything which could either connect indirectly to the Control System For Drone and Internet of Things Systems through other Drone(s) and/or Internet of Thing(s) systems through either wired and/or wireless means or connect directly to a control system including but not limited to connection hubs and control centers through either wired and/or wireless means which would be able to send commands to Drones, Internet of things Systems, and other Operators and transmit and/or receive messages to and from the Control System For Drone and Internet of Things Systems and anything either connected indirectly to the Drone and Internet of Thing Control System through other Drone(s) and/or Internet of Thing(s) systems through either wired and/or wireless means or connected directly to a control system including but not limited to connection hubs and control centers through either wired and/or wireless means. In an advantageous embodiment of my invention Drones and Internet of Things systems and control system apparatuses including but not limited to connection hubs and control centers could be controlled by other specified Drone(s) and/or Internet of Things system(s) and control system apparatus (es) including but not limited to connection hub(s) and control center(s) and be made to do certain task(s) with certain message(s). In an advantageous embodiment of my invention any message could include a Control System For Drone and Internet of Things Systems or other authority given identifying number of the system which sent said message. In an advantageous embodiment of my invention a system could be a Drone, Internet of Things System, or control system including but not limited to a connection hub or control center. In another advantageous embodiment of my invention every message could include the address which resent the message in addition to the original sender of the message. The line at 13 represents a connection through either wired and/or wireless means. An advantageous embodiment of a wired connection means in my invention could be a Fiber-Optic cable through which two systems could communicate through. Another advantageous embodiment of a wireless connection means in my invention could be a wireless radio system with both systems communicating with each other by sending and receiving wireless radio signals. An advantageous embodiment of a either a wired and/or wireless connection in my invention could also facilitate checking for information missing in a message and give the recipient of the message the ability to request any missing information. In another advantageous embodiment of my invention the connection means could create the possibility for simultaneous data transmission and reception between systems which were connected directly or indirectly through either wired and/or wireless means. In yet another advantageous embodiment of my invention both systems could transmit in small binary packages between each other. In another advantageous embodiment of my invention you can transmit a packet of any size and any format, and force whoever is sending the message to include personal information such as location, current speed it is traveling at, or what kind of system it is, etc., or not forcing the sender of a message to include any identifying or personal information at all in message(s) they could send. At 14 there is an Internet of things System which in an advantageous embodiment of my invention of my Control System For Drone and Internet of Things Systems an Internet of things System could be anything that could connect to the Control System for Drone and Internet of Things Systems indirectly through other Drone(s), and/or Internet of Things System(s) through either wired and/or wireless means or directly to transmit and/or receive messages through the Control System For Drone and Internet of Things Systems control system apparatuses including but not limited to connection hubs and control centers, and anything connected to the Control System for Drone and Internet of Things Systems directly or indirectly including but not limited to Drones, Internet of things system Systems through either wired and/or wireless means, and control system apparatuses including but not limited to connection hubs and control centers. At 15 there is a connection hub which in an advantageous embodiment of my invention Drones, Internet of things Systems, and control system apparatuses including but not limited to connection hubs and control centers would either be able to connect via wired and/or wireless means indirectly through other Drones and Internet of Things systems and control system apparatuses including but not limited to connection hubs and control centers or directly to a connection via wired and/or wireless means to the connection hub. In an advantageous embodiment of my invention the connection hub would be able to transmit messages to anything connected either directly and/or indirectly to the Control System For Drone and Internet of Things Systems and any control system apparatuses including but not limited to connection hubs connected to the Control System For Drone and Internet of Things Systems, receive messages from anything connected to the Control System For Drone and Internet of Things Systems either directly and/or indirectly and any control system apparatuses including but not limited to connection hubs and control centers connected to the Control System For Drone and Internet of Things Systems, and to resend all messages not addressed to it from any of its connections to all of the Drones and Internet of Things Systems and control system apparatuses including but not limited to connection hubs and control centers. In another advantageous embodiment of my invention the connection hub would only pass on any messages not destined for it to all of its connections except the connection that originally sent it the message not addressed to it. At 16 there is a control center which in an advantageous embodiment of my invention Drones and Internet of things Systems and control system apparatuses including but not limited to connection hubs and control centers would be able to either connect indirectly to through other Drone(s) and/or Internet of Thing(s) systems through either wired and/or wireless means or connect directly to a control center through either wired and/or wireless means, and the control center would be able to transmit messages to anything connected to the Control System For Drone and Internet of Things Systems either directly and/or indirectly and any control system apparatuses including but not limited to connection hubs and control centers connected to the Control System For Drone and Internet of Things Systems or any control system apparatus(es) including but not limited to connection hubs and control centers which make the system up, receive messages from anything connected to the Control System For Drone and Internet of Things Systems either directly and/or indirectly and any control system apparatuses including but not limited to connection hubs connected to the Control System For Drone and Internet of Things Systems or any control system including but not limited to connection hubs and control centers which make the system up, and to pass along messages not addressed to it from any of its connections to all of its connections. In another advantageous embodiment the control center would only pass on any messages not addressed for it to all of its connection except the connection it received the message not addressed to it. In an advantageous embodiment of my invention all systems including but not limited to Drones, Internet of things system Systems, and control system apparatuses including but not limited to connection hubs and control centers could be controlled by computer systems. In an advantageous embodiment of my invention, a system which can facilitate the indirect connection to a Drone, Internet of Things System, and/or a control system including but not limited to a connection hub and control center would be able to stop facilitating indirect connection to Drone(s), Internet of Things System(s), and/or control system apparatus(es) including but not limited to connection hub(s) and control center(s) is so desired, and Drones, Internet of Things Systems could have the option of not connecting to a control system including but not limited to a connection hub or control center indirectly if so desired.

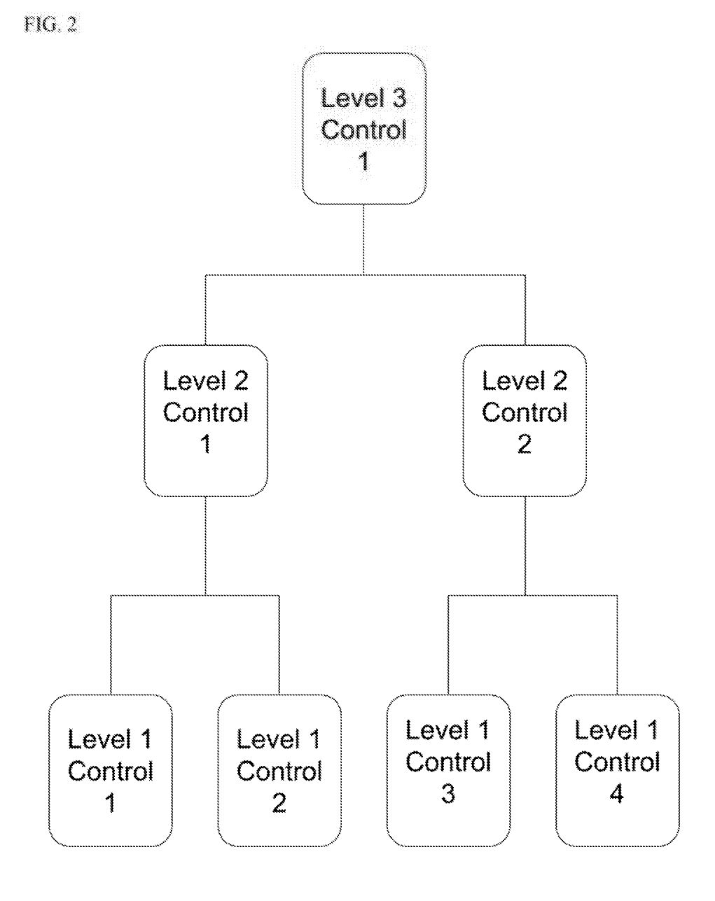

In FIG. 2 there is a possible control center hierarchy, and in an advantageous embodiment of my invention all control information could be distributed to all or some control system apparatus(es) which could be controlled specified control system apparatus(es), and these specified control system apparatus(es) could also be controlled by other specified control system apparatus(es), and specified control system apparatus(es) could also give this ability to other control system apparatus(es) over other specified control system apparatus(es), and each control center would also be able to control the Internet of things system, Drones, and the traffic of Drones either directly and/or indirectly connected to the Control System For Drone and Internet of Things Systems via wired and/or wireless means and which they are approved to control by other specified control system apparatus(es). In an advantageous embodiment of my invention specified control centers could control and monitor other control centers. In another advantageous embodiment of my invention specified control centers could operate autonomously to a specified degree and could be specified by other systems including but not limited to Drones and Internet of Things Systems and control system apparatuses including but not limited to connection hubs and control centers. In an advantageous embodiment of my invention specified control system apparatus(es) could be chosen by both other specified control system apparatus(es) and/or manually by human(s).

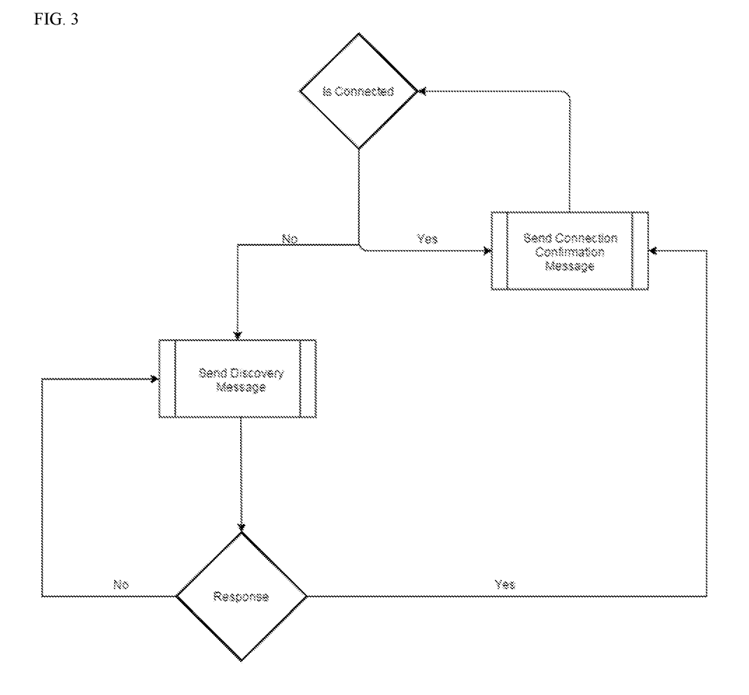

In FIG. 3 there is a flow chart describing the process of connecting to the Control System For Drone and Internet of Things Systems through either connect indirectly to the Control System For Drone and Internet of Things Systems through other Drone(s) and/or Internet of Thing(s) systems through either wired and/or wireless means or connect directly to a control system including but not limited to connection hubs and control centers through either wired and/or wireless means. The connection confirmation message will return false if no response message is received within a specified amount of time or at all, or there is a message which says that it must disconnect within a specified time and that time is up, what the system was connected to connect itself to the Control System For Drone and Internet of Things Systems has sent a message which say it will not connect said device to the Control System For Drone and Internet of Things Systems any longer.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages, as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

### REFERENCE NUMERALS

11 Drone
12 Operator
13 Wired and/or Wireless Connection
14 Internet of Things System
15 Connection Hub
16 Control Center

### Operation

In operation one would rely on the control logic programmed into the control centers to control the traffic of Drones and rely on the control system apparatuses including but not limited to connection hubs and control centers and the Control system for Drones and Internet of things system currently connected to the Control System For Drone and Internet of Things Systems. If desired one could shut the entire Control System For Drone and Internet of Things Systems or manually control the traffic of Drones by interfacing with certain control centers. One could also partially control Drone traffic with human beings interfacing with the computer controlled control system apparatuses including but not limited to connection hubs and control centers to manually direct Drone Traffic. One could also either partially or fully manually deliver messages sent out by the Control System For Drone and Internet of Things Systems and anything either directly and/or indirectly connected to it.

1. A control system for drone(s) and internet of things system(s), comprising:
a. drone(s) and/or internet of things system(s)
b. Communicating directly and/or indirectly
c. via Various possible connection mediums
d. which may or may not be facilitated by Control Center(s) and/or Connection Hub(s)
A control system for drone(s) and internet of things system(s), allowing
a. Direct and/or indirect communication amongst operator(s), drone(s), and/or internet of things system(s) to perform desired or undesired action(s) and
b. to communicate desired or undesired message(s) to desired and/or undesired recipient(s)
c. and to determine connection status among its drone(s) and internet of things system(s)
